(19) United States
(12) Patent Application Publication
(10) Pub. No.: US 2005/0044060 A1
(43) Pub. Date: Feb. 24, 2005

(54) Filtering process for information retrieval systems

(76) Inventors: Yuh-Cherng Wu, San Jose, CA (US); Bernhard Kohlhaas, Mountain View, CA (US); Horatiu-Zeno Simon, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/780,173

(22) Filed: Feb. 17, 2004

Related U.S. Application Data
(60) Provisional application No. 60/496,201, filed on Aug. 18, 2003.

(51) Int. Cl. G06F 7/00

(52) U.S. Cl. 707/1

(57) ABSTRACT

One embodiment of the invention provides a computer-implemented method for retrieving information from a knowledge base. In this embodiment, the method includes building a search request that contains a search query and a pattern having a set of attributes. The method further includes using the search request to retrieve information from the knowledge base. The retrieved information contains information associated with the search query. In addition, the retrieved information is associated with the set of attributes contained in the pattern.

### RELATED APPLICATION

The present application claims the benefit of the filing date of U.S. Provisional Application No. 60/496,201, which was filed on Aug. 18, 2003.

### TECHNICAL FIELD

This invention relates to a filtering process that may be used in information retrieval systems.

### BACKGROUND

In today's technology age, information and information sources are plentiful. On the World Wide Web, for example, individuals are capable of accessing many sorts of information from all over the world. Database and web servers may provide Internet users with information about fixing a car, critiquing a movie, buying products or services, and the like. By using search engines, an individual can quickly and easily search for information by entering a series of search terms.

Search engines often provide classification and retrieval services. For example, some search engines have various “spiders” that crawl through the World Wide Web and search for web sites and web-site content. These search engines then classify the information from these web sites using classification and indexing schemes. A master index may be used to store references to the various web sites that have been classified. Certain classification terms may be associated with the entries stored in the master index. Then, when an individual enters one or more search terms during a search operation, the search engine references its index to locate web-site references having terms that match those from the user's search request. The search engine is able to provide a list of pertinent web sites in sorted order.

Because of the growing amount of data on the World Wide Web, it often may be difficult for users to sort through the abundant amount of information provided by search engines. Although a user may be able to enter a series of search terms in hopes of limiting the search, the user may still be presented with hundreds, or even thousands, of “hits.” It may also be difficult for users to customize their searches for information contained in specific information sources or knowledge bases.

Some systems attempt to improve the filtering of search results through the use of itemized access lists. For example, meta data can be used to provide itemized information about access permissions for a given document. If a document X exists and is available on the World Wide Web, it could have an access list associated with it that includes all of the users who have permission to access document X. Another option is to maintain access lists associated with a particular user or application, wherein the access lists contain references to each document to which the user or application has access. However, it often takes time and effort to maintain these types of access lists. In addition, the lists are typically very specialized to the types of users or applications that exist in a particular run-time system.

### SUMMARY

Various embodiments of the present invention are provided herein. One embodiment of the invention provides a computer-implemented method for retrieving information from a knowledge base. In this embodiment, the method includes building a search request that contains a search query and a pattern having a set of attributes. The method further includes using the search request to retrieve information from the knowledge base. The retrieved information contains information associated with the search query. In addition, the retrieved information is associated with the set of attributes contained in the pattern.

There may be various benefits or advantages to certain embodiments of the present invention. For example, in one embodiment, an application is able to retrieve search results from any given knowledge base using a particular security strategy. A security strategy can effectively determine a set of attribute values to be associated with a control entity, such as a user name, country code, region, organization, or the like. The information retrieval process provides the application with a filtered set of search results, each of which is associated with the same set of attribute values. As such, the application is able to process the search results that are pertinent to the given security strategy.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an information management system, according to one embodiment of the invention.

FIG. 2 is a block diagram of a portion of the information management system shown in FIG. 1, according to one embodiment of the invention.

FIG. 3 is a flow diagram of a method for configuring various of the components shown in FIG. 2.

FIG. 4 is a flow diagram of a method for creating and assigning a security profile, according to one embodiment of the invention.

FIG. 5 is a flow diagram of a method for creating a security pattern, according to one embodiment of the invention.

### DETAILED DESCRIPTION

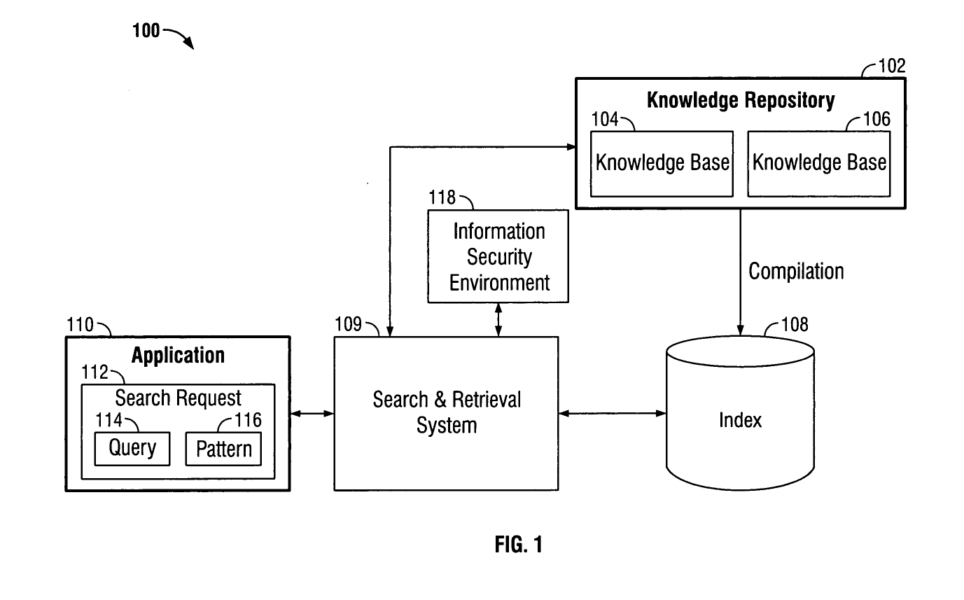

FIG. 1 is a block diagram of an information management system 100, according to one embodiment of the invention. In this embodiment, the system 100 includes a knowledge repository 102, an index 108, a search and retrieval system 109, an information security environment 118, and an application 110. In the system 100, the application 110 is capable of retrieving information from a knowledge base 104 or 106 using the search and retrieval system 109 and the information security environment 118. The application 110 creates a search request 112 that contains a search query 114 and a pattern 116 having a set of attribute values. The search request 112 is then used by the search and retrieval system 109 and by the information security environment 118 to retrieve information from the knowledge base 104 or 106. In one embodiment, an index 108 is utilized during the search process. The information retrieved from the knowledge base 104 or 106 contains information that is associated with the search query 114 and also associated with the set of attribute values contained in the pattern 116.

The knowledge repository 102 contains a number of different knowledge bases, such as the knowledge bases 104 and 106. The knowledge bases 104 and 106 store various forms of knowledge, or information. For example, the knowledge bases 104 and 106 could contain problem information, solution information, business information, service order information, and the like. The knowledge bases 104 and 106 could also be customized knowledge bases that are tailored to the specific implementation of the system 100. On the other hand, the knowledge bases 104 and 106 may also be off-the-shelf knowledge bases, such as vendor-provided databases.

The information contained in the knowledge bases 104 and 106 within the knowledge repository 102 is compiled into the index 108. The compilation process may use a standard classification scheme, or may use a customized classification scheme that is tailored to the type of information contained in the knowledge bases 104 and 106. The index 108 contains the compiled entries for all of the information contained in the knowledge bases 104 and 106.

The application 110 may be any form of front-end software application, such as a web client application, a windows-based application, and the like. The application 110 provides the search request 112 that is used for search and retrieval operations. The search request 112 contains the search query 114 and the pattern 116. The search query 114 is provided by the application 110, and may be created as a result of user input. For example, a user may enter one or more knowledge base search terms using a graphical user interface (GUI), or enter one or more search attributes. The knowledge base search terms will typically include textual entries. These terms and/or attributes would then be incorporated into the search query 114. The pattern 116 contains a set of attribute values. The pattern 116 may include a series of attribute name-value pairs. The attribute values contained in the pattern 116 may be derived from user input. Alternatively, the values may be created by application 110, or derived from an external source, such as the information security environment 118, which is coupled to the search and retrieval system 109. In one embodiment, the set of attribute values contained within the pattern 116 are combined using a set of logical AND/OR operations, as will be later discussed. In one embodiment, the search query 114 may be empty, in which case the search request will contain only the set of attribute values contained within the pattern 116. In one embodiment, additional patterns or queries may be included within the search request 112.

Once the search request 112 has been created, it is sent by the application 110 to the search and retrieval system 109 for search and retrieval operations. The search and retrieval system 109 will first conduct a search operation using the index 108 to search for entries that are associated with the search query 114 and the pattern 116. To do so, the search and retrieval system 109 uses the information security environment 118 during the search operation. In one embodiment, the search operation will use the index 108 to search for entries that are associated with all of the search queries and patterns within the search request 112, in those instances where the search request 112 contains multiple queries and patterns. These entries may be associated with information contained in either of the knowledge bases 104 or 106. For example, the search and retrieval system 109 could use the information security environment 118 to search in the index 108 for entries that contain the search terms or attributes contained within the search query 114 and that contain attribute values matching those contained in the pattern 116. These entries can then be retrieved and sent back to the application 110. In one embodiment, the application 110 displays the retrieved entries to a user via the graphical user interface (GUI).

At this point, the application 110 is capable of selecting one or more of these entries. In one embodiment, a user selects one or more of the entries on the application 110 using a GUI. In another embodiment, the application 110 automatically selects one or more of the entries. Upon selection, a retrieval request is sent from the application 110 to the search and retrieval system 109. The search and retrieval system 109 then retrieves the information from the knowledge base 104 and 106 corresponding to the entries selected by the application 110. This information is then routed back to the application 110.

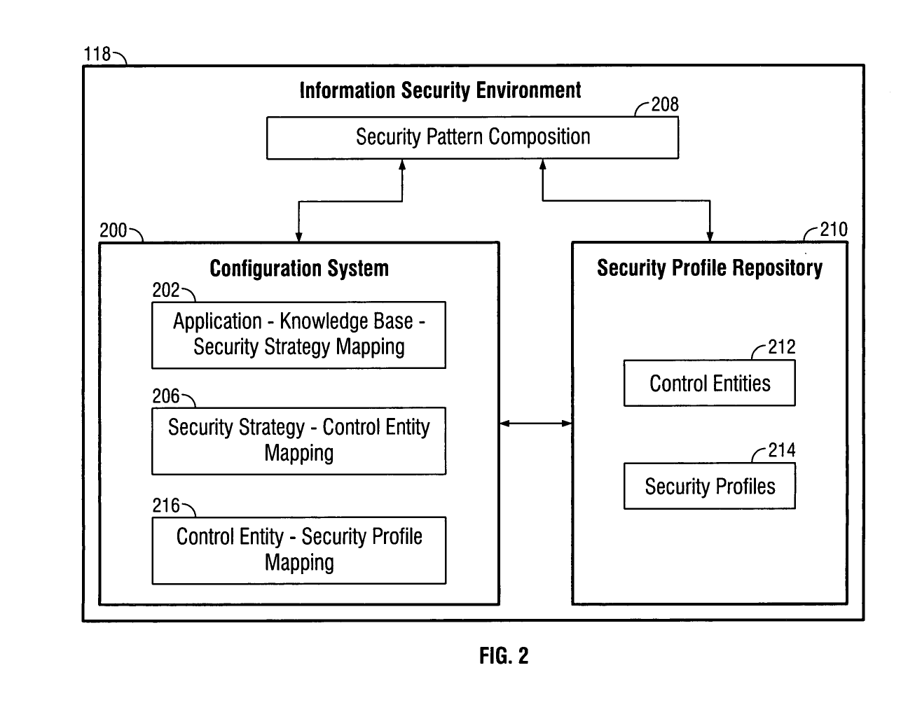

FIG. 2 is a block diagram of a portion of the information management system shown in FIG. 1, according to one embodiment of the invention. In FIG. 2, only the information security environment 118 is shown. In this embodiment, the information security environment 118 contains a configuration system 200, a security profile repository 210, and a security pattern composition function 208. The security pattern composition function 208 is coupled to both the configuration system 200 and the security profile repository 210. By utilizing these components of the information security environment 118, the search and retrieval system 109 is capable of processing a request to search for information in one of the knowledge bases 104 or 106.

The configuration system 200 first determines a search strategy that is to be used. The search strategy is associated with one of the knowledge bases 104 or 106. The security pattern composition function 208 uses the search strategy to create one or more patterns each having a set of attribute values to be used when searching for information in the knowledge base 104 or 106 that includes substantially the same set of attribute values.

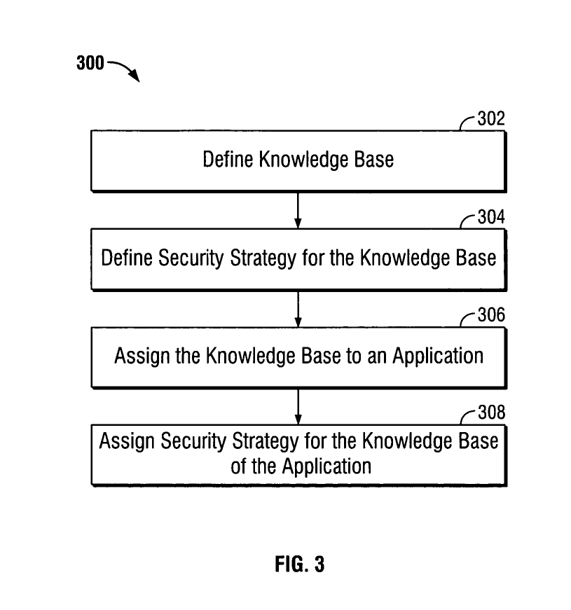

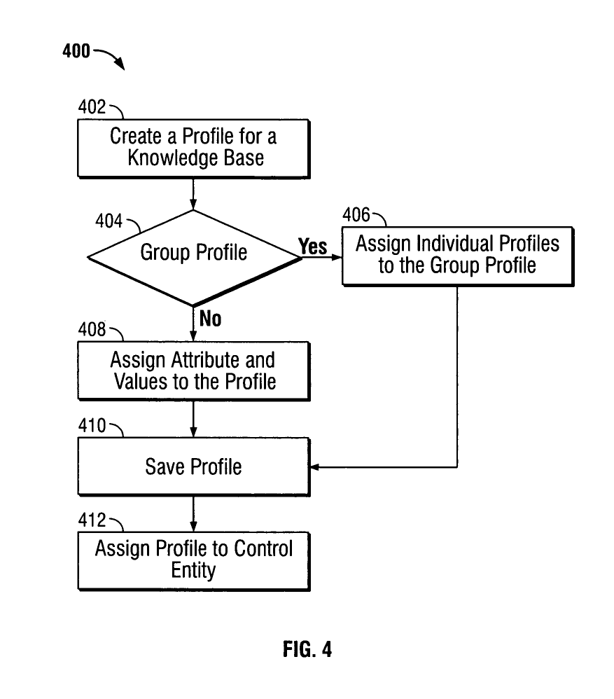

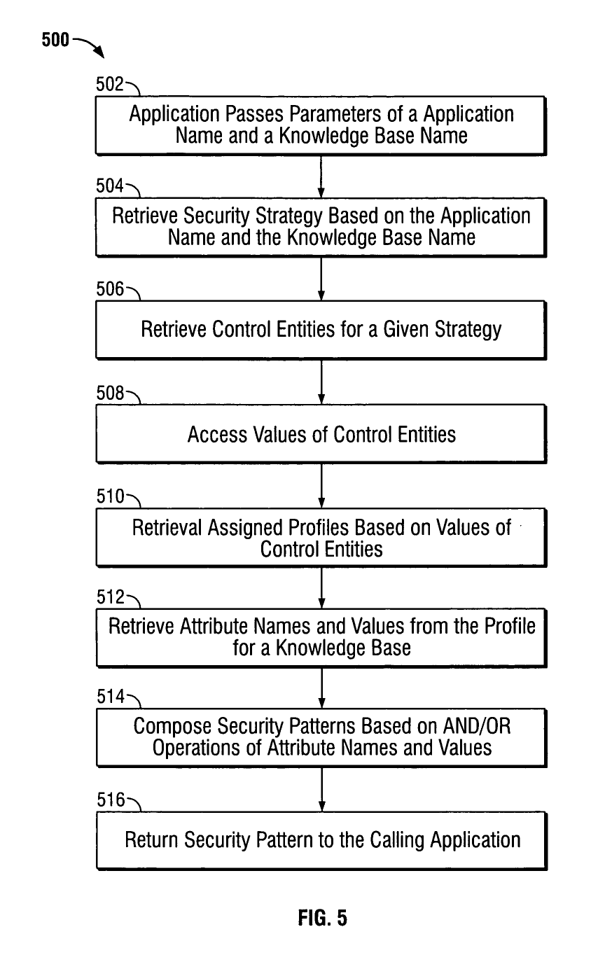

In one embodiment, the method of operation of the components shown in FIG. 2 can be described by the flow diagrams shown in FIG. 3, FIG. 4, and FIG. 5. FIG. 3 is a flow diagram of a method for configuring various of the components shown in FIG. 2. The method 300 shown in FIG. 3 includes method elements 302, 304, 306, and 308. In the method element 302, a knowledge base, such as the knowledge base 104 or 106, is defined. The defined knowledge base is contained within the knowledge repository 102. The defined knowledge base may hold any form of information, such as business solution information, business problem information, business partner information, service order information, or the like.

In the method element 304, a security strategy is defined for the knowledge base 104 or 106. In one embodiment, only one security strategy is assigned to a knowledge base. In another embodiment, more than one security strategy may be assigned to a knowledge base. A security strategy provides the high-level strategy for access provisions to any given knowledge base. The security strategy is associated with one or more control entities that may be provided with access to the knowledge base. For example, a control entity may be an individual user or an organization. In this example, the user or organization can be associated with a particular security strategy that is defined for a given knowledge base. The user or organization may then be provided with access to this knowledge base.

In the method element 306, the knowledge base 104 or 106 is assigned to the application 110 via a mapping function 202 in the configuration system 200. The mapping function 202 provides a direct mapping between the application 110 and the knowledge base 104 or 106.

Finally, in the method element 308, the security strategy for the knowledge base 104 or 106 is assigned to the application 110 via the mapping function 202. In this fashion, the security strategy is bound to the application 110 to determine the access that the application 110 will have into the knowledge bases 104 or 106. For example, the security strategy may provide that a user “A” will have access to the knowledge base 104. When this security strategy is assigned to the application 110, the user “A” using the application 110 will then have access to the knowledge base 104.

FIG. 4 is a flow diagram of a method for creating and assigning a security profile to one or more control entities, according to one embodiment. The method 400 shown in FIG. 4 includes method elements 402, 406, 408, 410, and 412, and also includes a checkpoint 404. In the method element 402, a security profile for a knowledge base 104 or 106 is created in the security profile repository 210 and stored in the set of security profiles 214. One or more security profiles may be created for each of the knowledge bases 104 or 106.

The checkpoint 404 determines whether a given profile is a group profile or an individual profile. A group profile is one that contains a number of distinct individual profiles. If the given profile is a group profile, then individual profiles may be assigned to the group profile in the method element 406. If the given profile is not a group profile, but rather an individual profile, then a number of attribute-value pairs are assigned to the profile. The attributes are associated with the type of information stored in the knowledge base 104 or 106. For example, if the knowledge base 104 were a business problem or solution knowledge base, then the attributes could relate to a symptom type, a status, a validation category, a priority type, a priority level, etc. These attributes correspond to the information stored in the knowledge base. Each of these attributes may have an associated value. For example, a priority level attribute may have an associated value of “1.” A number of these attribute-value pairs are assigned to a given profile in the method element 408.

In the method element 410, the security profile is saved in the set of security profiles 214 within the security profile repository 210. The profile may be saved in memory and/or on a storage device medium, such as a hard drive medium. Finally, in the method element 412, the security profile is assigned to a control entity. In one embodiment, a control entity corresponds to a business entity operative in the application 110. For example, in this embodiment, a control entity could be a user name, a country code, a region, a time zone, an organization, or any combination of these. All of the control entities 212 that are operative in the application 110 are stored in the security profile repository 210. The mapping functions 216 of the configuration system 200 identify the mappings, or assignments, between the control entities 212 and the security profiles 214. In one embodiment, a given control entity may be assigned to more than one security profile. In one embodiment, a given security profile may be assigned to more than one control entity.

FIG. 5 is a flow diagram of a method for creating a security pattern, according to one embodiment. The method 500 shown in FIG. 5 includes method elements 502, 504, 506, 508, 510, 512, 514, and 516. Upon execution of the method 500, one or more security patterns are generated and can be used by the application 110 for retrieving information from a knowledge base, such as the knowledge base 104 or 106. In the method element 502, the application 110 provides an application name and a knowledge base name to the configuration system 200. The application 110 passes these names as input parameters to the configuration system 200. The application name corresponds to the name of the application 110. The knowledge base name corresponds to the name of one of the knowledge bases 104 or 106.

In the method element 504, the application 110 obtains a security strategy from the configuration system 200 based on the application name and the knowledge base name. The configuration system 200 uses the application/knowledge base/security strategy mapping function 202 to determine which security strategy is to be passed back to the application 110. The mapping function 202 uses the application and knowledge base names provided by the application 110 to identify the appropriate security strategy. For example, if the application 110 provides an application name “APP,” which corresponds to the name of the application 110, and a name for the knowledge base 104, the mapping function 202 could identify a security strategy “A.” If, however, the application 110 were to provide an application name of “APP” and a name for the knowledge base 106, the mapping function 202 could identify a security strategy “B.” Because the mapping function 202 determines the mapping, the application 110 does not need to maintain this type of mapping information. This provides an advantage in the run-time operation of the application 110, because it is relieved of mapping maintenance overhead, and is also able to have a more generic external interface.

In the method element 506, the information security environment 118 retrieves a list of control entities for the given security strategy. The application 110 provides the security strategy obtained during the method element 504 to the information security environment 118, which then obtains the list of associated control entities. To achieve this functionality, the configuration system 200 uses the security strategy mapping function 206. The mapping function 206 maps each security strategy to a list of control entities associated with that strategy.

In the method element 508, the information security environment 118 accesses the values of the control entities in the list. To do so, the information security environment 118 accesses the control entities 212 in the security profile repository 210. The control entities 212 contain all of the control entity information that can be utilized by the information security environment 118. In one embodiment, the information security environment 118 then passes the values of these control entities back to the application 110. As noted earlier, the control entities could be of many different types, such as user name entities, organizational entities, and the like. The values of these control entities are stored in the security profile repository 210.

In the method element 510, the security profiles 214 that are assigned to the control entities identified in method elements 506 and 508 are retrieved. To do so, the mapping functions 216 in the configuration system 200 determine which of the security profiles 214 are assigned to the control entities 212. In one embodiment, there could be many different profiles that are assigned to a given control entity.

In the method element 512, the information security environment 118 retrieves the attribute names and values for the security profiles 214 stored in the security profile repository 210. As noted earlier, each security profile contains a set of attribute names and values. In one embodiment, these names and values are stored in name-value pairs. In this embodiment, each of the name-value pairs for each of the security profiles 214 are utilized by the information security environment 118.

In the method element 514, the security pattern composition function 208 in the information security environment 118 is used to compose a security pattern. In one embodiment, the security pattern is a table that is composed using AND/OR operations for the attribute names and values provided during the method element 512. For example, a security profile may be assigned to a user (i.e., control entity) who has authorization to access problems of a given problem type and status in a knowledge base, such as the knowledge base 104 or 106. The attribute names and values for this security profile could be as follows:

TABLE 1

| Attribute Name | Attribute Value |
|---|---|
| Problem Type | A |
| Problem Type | B |
| Status | RELEASED |
| Status | CREATED |

The security pattern composition function 208 is capable of processing these attribute names and values and generating a table that is composed of AND/OR operations for these attribute names and values. For example, the security pattern composition function 208 could determine that the attribute names and values shown in Table 1 should be represented in a Boolean expression “(Problem Type=A or B) and (Status=RELEASED or CREATED),” and could then generate the corresponding security pattern, or table, shown below:

TABLE 2

| | OPERATION | | | |
|---|---|---|---|---|
| Row | TYPE | NAME | OPERATION | VALUE |
| 1 | LPA | | | |
| 2 | | type | EQ | A |
| 3 | OR | | | |
| 4 | | type | EQ | B |
| 5 | RPA | | | |
| 6 | AND | | | |
| 7 | LPA | | | |
| 8 | | status | EQ | RELEASED |
| 9 | OR | | | |
| 10 | | status | EQ | CREATED |
| 11 | RPA | | | |

In Table 2 above, the “OPERATION TYPE” field may be set to “LPA” (left parenthesis), “RPA” (right parenthesis), “OR”, “AND”, or “NOT”, as determined by the Boolean expression. The “NAME” field may be set to “type” or “status.” The “OPERATION” field may be set to “EQ” (equal), “NEQ” (not equal), “GT” (greater than), “GE” (greater than or equal to), “LT” (less than), or “LE” (less than or equal to). The “VALUE” field may be set to “A,” “B.” “RELEASED,” or “CREATED.” The security pattern shown in FIG. 2 is one potential representation of the Boolean expression identified from the example security profile described above. In other embodiments, other forms of security patterns may be used to represent the Boolean expressions.

In the example above, there was only one security profile assigned to the specified control entity, and only one security pattern was generated. In one embodiment, the security pattern composition function 208 may generate two separate security patterns rather than one. For example, the first generated security pattern could be based on the first part of the Boolean expression “(Problem Type=A or B)” and the second generated security pattern could be based on the second part of the Boolean expression “(Status=RELEASED or CREATED).”

In certain scenarios, there may be more than one security profile assigned to a given control entity. In these scenarios, the security pattern composition function 208 is capable of generating more than one security pattern that is passed back to the application 110. In one embodiment, the security pattern composition function 208 generates one pattern per profile. The attributes and values for each profile are used in determining the Boolean expressions for each of the patterns. In another embodiment, however, the security pattern composition function 208 generates multiple patterns for each assigned profile. The constituent portions of the Boolean expressions for each profile are used in generating each pattern. In still another embodiment, the security pattern composition function 208 generates one global pattern for all of the assigned profiles. The attributes and values from all of the profiles are used in determining the Boolean expressions for the global pattern.

Finally, in the method element 516, the information security environment 118 provides the generated security patterns to the application 110. The application 110 is then able to use these patterns, in conjunction with one or more queries, to build a request to search for information in a knowledge base, such as the knowledge base 104 or 106. For example, as shown in FIG. 1 (described above), the application 110 may create a search request 112 that contains a query 114 and a pattern 116. In one embodiment, the pattern 116 shown in FIG. 1. is provided by the information security environment 118.

A number of embodiments of the invention have been described. Nevertheless, it will be understood that various modifications may be made without departing from the spirit and scope of the invention. For example, various embodiments on the invention may include functionality that is provided on software, hardware, or a combination of software and hardware. In certain embodiments, the software may be stored or contained on a computer-readable medium, such as CD-ROM, floppy disk, or other storage mechanism. Functionality for elements such as the application 110, the search and retrieval system 109, the information security environment 118, the knowledge repository 102, and the index 108 may be embodied on such forms of computer-readable media. Other embodiments are also within the scope of the following claims.

1. A computer-implemented method for retrieving information from a knowledge base, the method comprising:
building a search request that contains a search query and a pattern having a set of attributes; and
using the search request to retrieve information from the knowledge base, wherein the retrieved information contains information associated with the search query, and wherein the retrieved information is also associated with the set of attributes contained in the pattern.

2. The computer-implemented method of claim 1, wherein the search query is input by a user.

3. The computer-implemented method of claim 1, wherein the method comprises:
using the search request to retrieve information from the knowledge base using a search index.

4. The computer-implemented method of claim 1, wherein the search query includes knowledge base search terms.

5. The computer-implemented method of claim 4, wherein the knowledge base search terms contain textual search terms.

6. The computer-implemented method of claim 1, wherein the pattern is associated with a control entity.

7. The computer-implemented method of claim 6, wherein the control entity is selected from a group consisting of a user name, a country code, a region, and a organization.

8. The computer-implemented method of claim 1, wherein the pattern contains a set of attributes that each have a name/value pair.

9. The computer-implemented method of claim 1, wherein the search request contains a second pattern having a set of attributes, and wherein the retrieved information is further associated with the set of attributes contained in the second pattern.

10. The computer-implemented method of claim 1, wherein the set of attributes contained in the pattern includes attributes selected from a group consisting of a symptom type, a status, a validation category, a priority type, and a priority level.

11. The computer-implemented method of claim 1, wherein the knowledge base is selected from a group consisting of a problem knowledge base, a solution knowledge base, and a business partner knowledge base.

12. A computer-implemented method for building a request to search for information in a knowledge base, the method comprising:
obtaining a search strategy that is associated with the knowledge base; and
using the search strategy to build a pattern having a set of attributes to be used when searching for information in the knowledge base, such that the information is associated with the set of attributes in the pattern.

13. The computer-implemented method of claim 12, wherein the search strategy is associated with one or more control entities.

14. The computer-implemented method of claim 13, wherein the control entities are each selected from a group consisting of a user name, a country code, a region, and a organization.

15. The computer-implemented method of claim 12, wherein the pattern contains a set of attributes that each have a name/value pair.

16. The computer-implemented method of claim 12, wherein the method further comprises:
using the search strategy to build a second pattern having a set of attributes to be used when searching for information in the knowledge base, such that the information is associated with the set of attributes in the pattern and also with the set of attributes in the second pattern.

17. The computer-implemented method of claim 12, wherein the set of attributes contained in the pattern includes attributes selected from a group consisting of a symptom type, a status, a validation category, a priority type, and a priority level.

18. The computer-implemented method of claim 12, wherein the knowledge base is selected from a group consisting of a problem knowledge base, a solution knowledge base, and a business partner knowledge base.

19. A computer-readable medium having computer-executable instructions contained therein for performing a method, the method comprising:
building a search request that contains a search query and a pattern having a set of attributes; and
using the search request to retrieve information from a knowledge base, wherein the retrieved information contains information associated with the search query, and wherein the retrieved information is also associated with the set of attributes contained in the pattern.

20. A computer-readable medium having computer-executable instructions contained therein for performing a method, the method comprising:
obtaining a search strategy that is associated with a knowledge base; and
using the search strategy to build a pattern having a set of attributes to be used when searching for information in the knowledge base, such that the information is associated with the set of attributes in the pattern.

21. A computer system for retrieving information from a knowledge base, the computer system being programmed to:
build a search request that contains a search query and a pattern having a set of attributes; and
use the search request to retrieve information from the knowledge base, wherein the retrieved information contains information associated with the search query, and wherein the retrieved information is also associated with the set of attributes contained in the pattern.

22. A computer system for building a request to search for information in a knowledge base, the computer system being programmed to:
obtain a search strategy that is associated with the knowledge base; and
use the search strategy to build a pattern having a set of attributes to be used when searching for information in the knowledge base, such that the information is associated with the set of attributes in the pattern.
